(19) United States
(12) Patent Application Publication
(10) Pub. No.: US 2003/0093262 A1
(43) Pub. Date: May 15, 2003

(54) Language translation system

(76) Inventor: Gines Sanchez Gomez, Mostoles (ES)

Correspondence Address: GINES SANCHEZ GOMEZ, CALLE CERVANTES, 1, 7, B, 28.932 - MOSTOLES (MADRID), ES

(21) Appl. No.: 10/288,808

(22) Filed: Nov. 5, 2002

(30) Foreign Application Priority Data
Nov. 15, 2001 (ES) P200102579

(51) Int. Cl. G06F 17/28

(52) U.S. Cl. 704/4

(57) ABSTRACT

Having two master sets of related real phrases in languages Source and Target, a phrase in the Source language is searched in the master Source set of phrases, choosing the master phrases with the same words and in the same sequence, and its related master Target phrases, deleting the not common words of the master Target phrases and choosing the master Target phrase more similar to the rest of master Target phrases.

### CROSS-REFERENCE TO RELATED APPLICATIONS

The U.S. Pat. No. 6,301,554 (Christy), dated Oct. 9, 2001, about translation by predefined sentences.

### FIELD OF THE INVENTION

This invention belongs to the technical field of the translation of languages.

### BACKGROUND OF THE INVENTION

This invention translates phrases, proposing a system that only have in account very general and common linguist elements, specially in the occidental languages (lating or greek character).

### BRIEF SUMMARY OF THE INVENTION

I now consider written documents.

Having two set of real phrases, the first set in a Source language and the second set in a target language, having a relation between the two set one to one phrase, being said set so wide as possible, including literary, historic, legal, scientific, technical text, . . .

Specially the Bible, translated to all the languages and being numbered all its phrases and also the international treaties.

Putting a text in Source language on the side of its translated text in a Target language, by mean of the punctuation marks (point, comma, . . . ) it is possible to relate both texts phrase to phrase. So, each Source phrase FOi is related with a Target phrase FDi.

To translate a phrase FX1n with n words in Source language {PO1, PO2, . . . , POn}, the same is broken into sentences type FXij: {POi, POi+1, POi+2 . . . POj}, i<=j; phrases with all the word and with the same sequence that FXij are sought into the set of Source phrases FO, being rejected said sentence if no phrase is found.

If the length of some found phrases FOr is the same that the length of FXij(=j+1−i), their related FDr phrases are translations of FXij.

If the length of the found phrases FOr is larger that the length of FXij(j+1−i):

with only a phrase FOr the translation is not possible,

m>=2 phrases FOr, with its related FDr

In this last case, counting all the words of all the phrases FDr, each common word in all the phrases gives the m value, and each not common word gives the 1 value. Eliminating the words with summa 1 in the phrases FDr, there are m translation of the sentence FXij, being FD2rij.

To obtain the total translation of the phrase FX1 n:

if the words PDk, . . . , PDj of the sentence FD2rij coincide with the word PD2k, . . . , PD2j of the sentence FD2rkp, it is possible to link both sentences,

being k-j+1, ever it is possible to link said sentences.

### INDEX OF FIGURES

FIG. 1. Programmed function for patterns comparation

FIG. 2. Entering record to the master files of phrases

FIG. 3. General scheme to translate a text.

### DETAILED DESCRIPTION OF THE INVENTION

A computerized method to translate a text from a Source language to a Target language.

I define two linguist elements, being the paragraph breaker and the phrase breaker. The paragraph breaker is the point and new line and the phrase breaker the point on the same line, question mark, exclamation point, . . .

A patterns comparation function C(P1,P2). I start by this function out of sequence because the same is used forward. Starting from the pattern P1{P11, P12, . . . , P1N} and P2{P21, P22, . . . , P2N}, being the Pij signs to compare as letters, words, numbers, . . . , this function obtains a number C about the maximun of coincidences between the P1 and P2, having en account the sequence of the signs into each pattern:

symbols Aij are obtained each time that P1i=P2j,

said symbols Aij are sorted by i and j, obtaining the symbols Aij(r), being r the sequence,

a pattern solution PS1 is obtained with the symbol Aij(1), giving C(PS1)=1,

to the pattern PS1 is added the following symbol Akp(2) if k>i and p>j, giving C(PS1)=2,

if not k>i and p>j, the pattern PS2 is obtained with the symbols Akp(2). In this case C(PS1)=1 and C(PS2)=1,

the following symbols Amt(r) are added to all the existent pattern solutions, being the comparation symbol with each Amt(r) the last symbol of each patters solution. If not possible to add a symbol to a pattern solution, a new pattern solution is created with said symbol,

a pattern solution PSr( . . . , Aij) is deleted if exist other PSs( . . . , Aij), being C(PSs)>C(PSr),

the maximun C(PSr) is the searched C and the symbols Aij(r) of said PSr define a relation between P1 and P2.

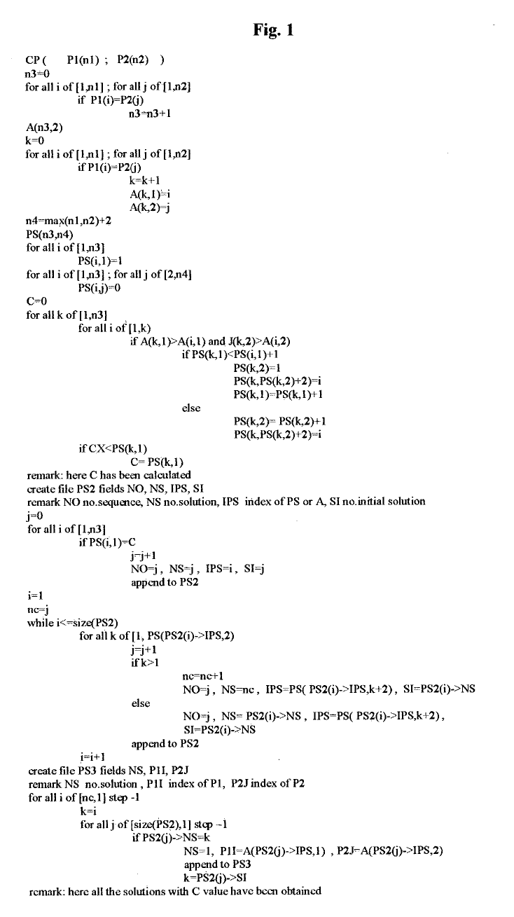

The operations of previous paragraph are specified in the computer program of the FIG. 1, suitable to be easily translated to any program language. The files PS2 y PS3 wourld be easily changed by dynamical arrays.

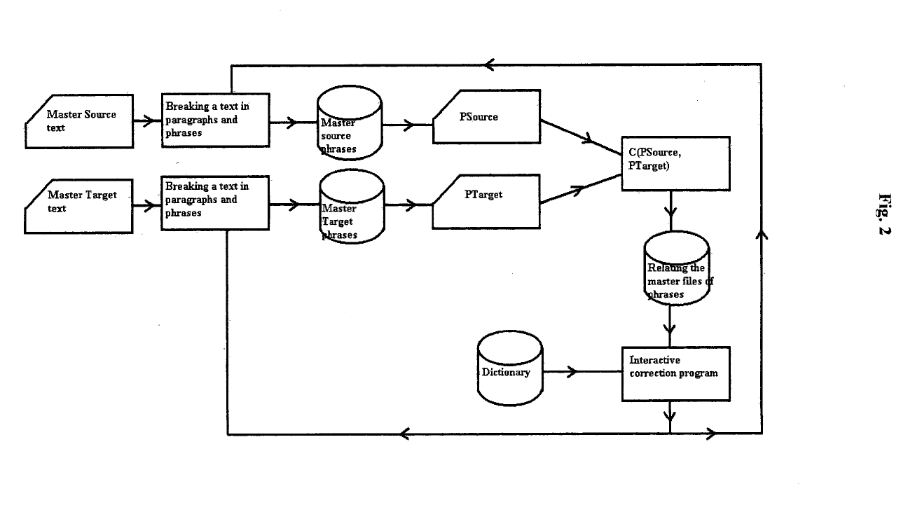

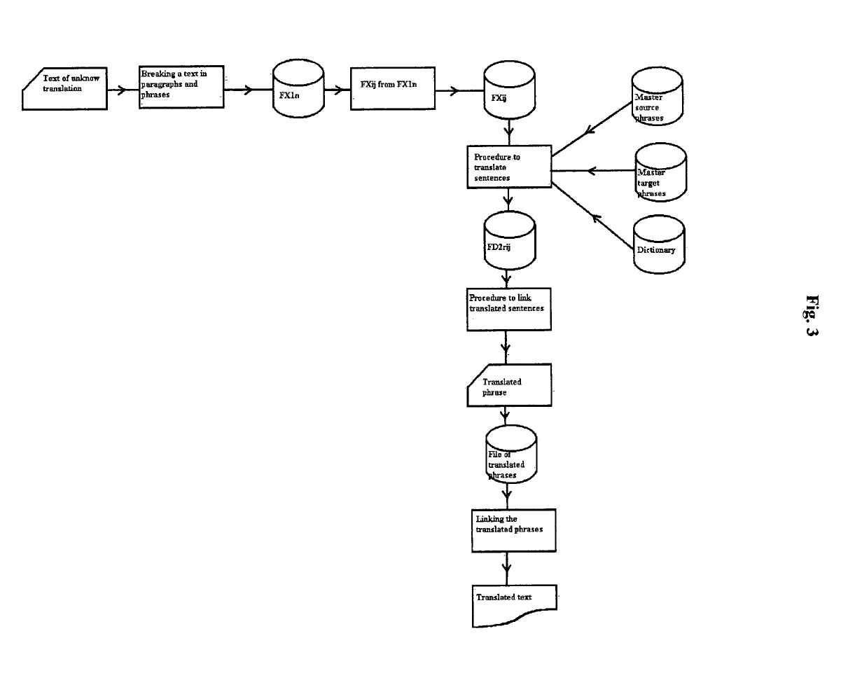

The method comprises the following consecutive steps, schematized in the FIGS. 2 and 3:

Creation of files of master phrases in the languages Source and Target. Both files have the same structure. The files are obtained from literary, historic, legal, scientific, technical texts, . . . , specially the Bible and international treaties.

Each record of each file comprising the following fields:

name of the text

paragraph number (into of each text)

phrase number (into each paragraph)

phrase

A computerized embodiment of said files is obtained scanning texts, while a program for breaking a text in paragraphs and phrases break said texts according with the paragraph and phrase breakers, assigning paragraph and phrase number at the time that the computer engrave each record into a computerized file.

Relating the master files of phrases Source and Target. For each text in each language, a PSource and a PTarget patterns are made, being each element of said patterns the number of phrases into the respective paragraphs.

By using the pattern comparation function C(PSource,PTarget), a relation between the paragraph Source and Target are obtained, being given by the symbols Aij of the solution patterns. If by all i, I=j, each phrase of the Source language are linked by each phrase of the Target language. In general, each phrase Source FOi is related with a phrase Target FDi.

If not i=j by all i, there are a leap between the paragraph of both texts. It is possible to ignore said leap, meaning the symbols Aij as defining a relation between paragraph. Said symbols and the name of the text are stored in a file.

It is possible to correct this leaps if a translator of the languages Source and Target changes the texts, adding the necessary breakers of paragraph and phrase. Said translator could be helped by an interactive correction program that shows a view of said text, putting one at side of the other, and two additional column by each text, with the phrase and paragraph number, so that two related paragraph start on the same line.

Breaking a text in the Source language in phrases. The program for breaking a text in paragraphs and phrases break a text of unknow translation according with the paragraph and phrase breakers, assigning paragraph and phrase number at the time that the computer engrave each record into a computerized file, being each record one phrase.

Obtaining sentences FXij from the phrase to translate FX1n in Source language with the word {OP1, . . . , OPn}. All word of any sentence are consecutive regarding the source phrase:

starting from the first word OP1, the same defines the sentence FX11{OP1},

other sentece is obtained adding to said sentence the following word OP2, giving FX11I+OP2=FX12 (OP1,OP2), also said OP2 defines the sentence FX22 (PO2),

adding the following word OP3 to all previous sentences, more new sentences are obtained, giving FX13, FX23, and also FX33,

similarly the following words OP4, . . . OPn are added,

summarising they are n.(n+1)/2 sentences, because said process can be assimilated to a arithmetic progresion with n elements and step=1.

But a lot of said sentences are not realistic, by suppressing the not realistic sentences only are permited the sentences that its first word is PO1 or it is preceded by a punctuation mark o conjuntion and its last word is POn or it is followed by a punctuation mark o conjuntion.

This could reduce very much the initial n.(n+1)/2 sentences.

Translating a phrase FX1n with n words in Source language {PO1, PO2, . . . , POn}.

Procedure to Translate Sentences

By each sentence FXij {POi, . . . , POj}, phrases with all the words and with the same sequence that FXij are sought into the master file of Source phrases FO, being rejected said sentence if no phrase is found.

If the length of some found phrases FOr is the same that the length of FXij(=j+1−i), their related FDr phrases in the master file of Target language are translations of FXij.

If the length of the found phrases FOr is larger that the length of FXij(j+1−I):

with only a phrase FOr the translation is not possible,

m>=2 phrases FOr, with its related FDr

In this last case, counting all the word of all the phrases FDr, each common word in all the phrases gives a value near to m, and each not common word gives a value near to 1. Eliminating the word with total near to 1 in all the phrases FDr, there are m translation of the sentence FXij, being FD2rij.

But some not common words, according to previous paragraph, would be synonym of common words, and also, some common words would be words frequentely used, specially if m is short.

These exceptions can be resolved with a security selection, b.e., fixing a value m>=2, and a security percentage. If the total value of a word n by said security percentage is above m it is a common word.

Likewise, having a bilingual dictionary Target-Source, some word initially common will be not common if its translation by mean of said dictionary does not coincide with no word of FXij (POi, . . . , POj}. In the opposite side, if some initially not common word is a synonym regarding other common word, the same will be a common word.

By deleting the not common word of the phrases FDr, there are m phrases (now sentences) FD2rij translation of the sentence FXij.

Procedure to Link Translated Sentences

To obtain total translations of the phrase FX1n:

only the sentences FXij with translations FD2rij are had in account,

starting with sentences with i=1, FX1j,

sentences as FXkp, being 1<k<j+1 y p>j, are tested,

if the words PDk, . . . , PDj of the sentence FDr1j coincide with the words PD2k, . . . , PD2j of the sentences FDrkp, deleting the common word of one of the sentences, we have m sentences FDr1p larger that FDr1j and FDrkp,

if k=j+1, then FDr1j and FDrkp are linked by putting FDrkp following FDr1j,

the process is repeated to reach the sentences FDr1n (now phrases).

Finally we have t phrases FDr1n, translations of FX1n.

To choose between said t phrases FDr1n, each phrase of FDr1n is compared with all other of said set FDr1n1 by mean of the pattern comparation function, being the words of each phrase the elements of each pattern, assigning to each phrase r the C=max[C(FDr1n,FDs1n)], by all s< >r. The phrase with bigger Cr and more short is chosen, being the translated phrase.

Each translated phrase is engraved in a file of translated phrases with the same number of paragraph and phrase that the FX of origin.

Linking a text from the file of translated phrases. A program computer reads all record of the file of the translated phrases, memorizing the number of paragraphs, inserting a phrase breaker between two records with the same paragraph number, and a paragraph breaker when the program reads a different paragraph number.

Simplifying the master files of Source and Target phrases. For avoiding repeated record, a phrase of the master Source file and its related phrase in the master Target file are suppressed temporary, being translated the Source phrase according the procedure of previous paragraphs. If the translated phrase obtained from the procedure is similar to the Target phrase, said phrases Source and Target are erased, else these phrases are entered again into the Source and Target master files.

Other Embodiment of the Invention

Improvement for Relating the Master Files Source and Target.

For avoiding a translator to verify the relation between the master files Source and Target, a percentage of success is established, b.e. 90%. Given two related phrases in languages Source and Target, and a dictionary, said phrases are confirmed as related if the number of words of the Source phrase with a related word in the Target phrase, according the dictionary and having in account any of its synonyms, is bigger that the percentage of success regarding the length of the Source phrase.

### INDUSTRIAL UTILIZATION

Simultaneous Translation of Several Languages.

N speaker in N languages. Each speaker having a computer with the following performances:

sound card for speaking

program to transfer a voice file to text file

program to transfer a text file to a voice file

text editor with orthographic corrector in the speaker language

keyboard with only the alfabet symbols in the speaker language, and a symbols to the breaker phrase,

All the computer are connected to a local network, with master files of phrases Language1, Language2, . . . , LanguageN.

When the speaker 1 acts, the computer shows on the screen the text that says, then the speaker corrects the orthographic mistakes. When a phrase is finished, the speaker strikes the phrase symbols.

Then the text editor transfer said written text to the program to translate its.

If the program translator finds a valid translation in any languages, this translation is transferred to numbered files according with the target language and the phrase sequence. The computers of the rest of the speakers read the files according to its language and sequence of phrase, transforming each written file in sound files, and playing said sound files.

If the translation program does not find a valid translation in no language, the computer shows on the screen of the acting speaker the most complete phrase obtained, in its own language, finding the sentences not translated, and suggesting a change of writing.

I claim for:

1. A computerized system for translating a text from a Source language to a text in a Target language comprising
a dictionary connecting all the words or their roots of the Source language with all the words or their roots of the Target language,
a master file of phrases in the Source language, each one of its records containing a phrase in the Source language, a name of the text origin of the phrase, a paragraph number into said text origin and a phrase number into each said paragraph,
a master file of phrases in the Target language, each one of its record containing the phrase in the Target language, the name of the text origin of the phrase, the paragraph number into said text origin, and the phrase number into each said paragraph,
a file relating said master files Source and Target, containing each one of its records the name of the text origin, the paragraph and phrase numbers of the phrase in Source language and the paragraph and phrase numbers of the phrase in Target language,
a programmed function for patterns comparation as the FIG. 1,
a program for breaking a text in paragraphs and phrases,
an interactive correction program with a translator to improve the relation between the master Sources and Target phrases files,
a program to obtaining a set of sentences from one phrase,
a program for translating sentences,
a program for linking translated sentences into a translated phrase,
a program for linking a text from the translated phrases.

2. A computer-controlled method to translate a text in the Source language to a text in the Target language, comprising
creating the master file of phrases in Source language,
creating the master file of phrases in Target language,
creating the file relating said master files Source and Target
breaking a text in paragraphs and phrases,
breaking the text to translate in the Source language in paragraphs and phrases in Source language,
for each phrase in Source language to translate, a set of sentences in Source language are obtained,
for each sentence in Source language, a set of master Source phrases are obtained, having each master Source phrase all the words of the sentence in source language and with the same sequence,
if said set of master Source phrases is empty, the sentence in Source language is not had in account, following with the next sentence,
a set of master Target phrases are obtained from its master file through the file relating the master files of phrases Source and Target,
obtaining translations sentences in Target language of the sentence in Source language from the set of master Target phrases,
linking all the obtained translation sentences in Target language, giving a translated phrase in Target language,
linking all the translated phrases in Target language, giving a translated text in Target language of the text in Source language.

3. The computer-controlled method of the claim 2, characterized in that for breaking a text in paragraph and phrases, when said text is read by the computer, the computer assigns a consecutive paragraph number when the computers reads a paragraph breaker and a consecutive phrase number when the computer reads a phrase breaker, being changed to zero each phrase number at beginning of a new paragraph, storing said phrase with its paragraph and phrase number in a file.

4. A computer-controlled method for creating the master files of phrases in Source and Target languages, according the claims 2 and 3, characterized in that each text in its respective language is broken in paragraphs and phrases, being engraved in its respective master file with the name of the text.

5. The computer-controlled method of the claim 4, characterized in that for creating the master files of phrases Source and Target are used texts already translated in the Source and Target languages, specially the Bible, international treaties, literary, historical, legal, scientific, technical, . . .

6. A computer-controlled method for creating the file relating the master files of phrases in Source and Target languages according the claims 2 to 4, comprising
creating a Source pattern with the number of the phrases of each paragraph of the Source text,
creating a Target pattern with the number of the phrases of each paragraph of the Target text,
both patterns are related by using the pattern comparation function,
each relation obtained from said pattern comparation and the name of the text is engraved as a record in said file relating the master files of phrases in Source and Target languages.

7. The computer-controlled method of the claim 6, characterized in that for minimizing the elimination of phrases of the master files of phrases in Source and Target languages, by each text entered in both master files,
a comparative text in six columns are made, having each column the paragraph and phrase Source number and the Source phrase itself, and the paragraph and phrase Target number and the Target phrase itself
said comparative text is showed on the computer screen,
while a language translator adds the paragraph and phrase breakers for adjusting the text in the Source language and the text in the Target language,
ending both text are entered again.

8. The computer-controlled method of the claim 6, characterized in that for improving the relation obtained from the patterns comparation, two phrases are confirmed as related if, fixing a percentage of success, the number of words of the Source phrase with a related word in the Target phrase, according to the dictionary and having in account any of its synonyms, is bigger that the percentage of success regarding the length of the Source phrase, being else suppressed the two phrases of its respective master files.

9. A computer-controlled method for obtaining a set of sentences in Source language from the each Source phrase, according the claim 2, comprising
starting from the first word of the phrase, being said word a sentence,
other new sentece is obtained adding to said sentence the second word, and also said second word defines a new sentence,
more new sentences are obtained adding to all previous sentences the third word of the phrase and also said third word defines a new sentence,
similarly the following words fourth, fifth, sixth, . . . are added,
if some sentences does not start with the first word of the phrase or these sentences are not preceded by a punctuation mark o conjuntion, said sentences are deleted,
if some sentences does not end with the last word of the phrase or these sentences are not followed by a punctuation mark o conjuntion, said sentences are deleted.

10. A computer-controlled method for obtaining translations sentences in Target language of the sentence in Source language from the set of master Target phrases according the claim 2, characterized in that
if any phrase of the master file of Source phrases matches with the sentence to translate, its related phrase in the master file of Target phrases is the translation of the sentence,
a m>=2 and a security percentage are else fixed,
there are n>=m master Source phrases with its related master Target phrases,
all the different words of the obtained master Target phrases are added, giving an amount by each word,
all the words of the master Target phrases which amount is under n by the security percentage are deleted,
so, n translations of the Source sentence are obtained.

11. The computer-controlled method of the claim 10, characterized in that the amount of a word is increased/decreased if translating said word by mean of a Target-Source dictionary said translation matches/does not match with some word of the master Source sentences.

12. A computer-controlled method for linking all the obtained translated sentences in the Target language according the claim 2, characterized in that all the translated sentences are linked two to two
if the last words of the first Source sentence matches with the beginning words of the second Source sentence, being the new translated sentence the addition of the two translated sentences by deleting in one the common words,
also if the two Sources sentences are consecutive, being the new translated sentence the addition of the two translated sentences,
including the new partial translations of the Source phrase to obtain its total translation.

13. A computer-controlled method according the claim 2, characterized in that for simplifying the master files of Source and Target phrases, a phrase of the master Source file and its related phrase in the master Target file are erased temporary, being translated the Source phrase, if the translated phrase obtained is similar to the Target phrase, said phrases Source and Target are erased of the respective master files of Source and Target phrases.

14. A computer-controlled method to translate a text in the Source language according the claims 6, 8 or 12, characterized in that to compare two patterns
a solution is created with a first coincidence between the two patterns,
a second coincidence are added to said solution if its sequence in the two patterns are bigger that the last coincidence of the solution, an other solution are else created with this second coincidence,
the following coincidences are used as the second coincidence,
the solutions with more coincidences are the final solutions.

15. Utilization of the invention for the simultaneous translation of several languages by several speaker, characterized in that
a computer by each speaker,
the computers are connected to a local network,
-the local network having linked files Language1, Language2, . . . LanguageN of related phrases,
sound card, program to transfer a voice file to text file, text editor with orthographic corrector in the speaker language, keyboard with only the alphabet symbols in the speaker language, a symbol by the phrase breaker, and a program to transfer a text file to a voice file,
when a speaker acts, its text editor shows the text that says, then the speaker corrects the ortographic mistakes and when a phrase is finished, the speaker strikes the phrase symbol,
then the text editor transfer said written text to the program to translate text,
the valid translations are transferred to numbered files according to the target language and the phrase sequence, while the computers of the rest of the speakers read this files, transforming each written file in sound files, and playing said sound files,
if the translation program does not find a valid translation in some languages, the computer shows on the screen of the acting speaker the most complete phrase obtained, in its own language, finding the sentences not translated, and suggesting a change of writing.
